(19) United States
(12) Patent Application Publication
(10) Pub. No.: US 2020/0088844 A1
(43) Pub. Date: Mar. 19, 2020

(54) SYSTEMS AND METHODS FOR IMPROVING DETECTION OF A RETURN SIGNAL IN A LIGHT RANGING AND DETECTION SYSTEM WITH PULSE ENCODING

(71) Applicant: Velodyne LiDAR, Inc., San Jose, CA (US)

(72) Inventors: Kanke GAO, Fremont, CA (US); Kiran Kumar GUNNAM, Santa Clara, CA (US); Rajesh RAMALINGAM VARADHARAJAN, San Jose, CA (US); Anand GOPALAN, Foster City, CA (US); David HALL, San Jose, CA (US)

(73) Assignee: Velodyne LiDAR, Inc., San Jose, CA (US)

(21) Appl. No.: 16/134,780

(22) Filed: Sep. 18, 2018

(51) Int. Cl. G01S 7/487; G01S 17/10

(52) U.S. Cl. CPC G01S 7/487; G01S 17/10

(57) ABSTRACT

Described herein are systems and methods for improving detection of a return signal in a light ranging and detection system (LiDAR). The method includes the following steps at the LiDAR system: encoding and transmitting a sequence of pulses based on a user signature. Then, receiving a multi-return signal based on a reflection off objects of the sequences of pulses. The multi-return signal may be decoded based on the user signature, and then authenticated the via a correlation calculation. The user signature may determine an amplitude of a first pulse in the sequence of pulses, an amplitude of a second pulse of the sequence of pulses, and an interval between the first pulse and the second pulse. A bit representation of the user signature is orthogonal to a bit representation of another user signature of another LiDAR system. The user signature may be dynamically adjusted by the LiDAR system.

### BACKGROUND

### A. Technical Field

The present disclosure relates generally to systems and methods for light transmission and reception, and more particularly to improving the accuracy and reliability of the detection by applying unique and identifiable light pulse sequences.

### B. Background

Light detection and ranging systems, such as a LiDAR system, may operate by transmitting a series of light pulses that reflect off objects. The reflected signal, or return signal, is received by the light detection and ranging system, and based on the detected time-of-flight (TOF), the system determines the range (distance) the system is located from the object. Light detection and ranging systems may have a wide range of applications including autonomous driving and aerial mapping of a surface. These applications may place a high priority on the security, accuracy and reliability of the operation. If another party intentionally or unintentionally distorts the laser beam or the return signal, the accuracy and reliability may be negatively impacted. In some embodiments, multi-return detection and pulse encoding of a laser beam may improve the performance of the LiDAR system.

Accordingly, what is needed are systems and methods for improving detection of a return signal in a light detection and ranging system.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 depicts the operation of a light detection and ranging system according to embodiments of the present document.

FIG. 2 illustrates the operation of a light detection and ranging system and multiple return light signals according to embodiments of the present document.

FIG. 3A depicts a LiDAR system with a rotating mirror according to embodiments of the present document.

FIG. 3B depicts a LiDAR system with rotating electronics in a rotor-shaft structure comprising a rotor and a shaft according to embodiments of the present document.

FIGS. 4A, 4B and 4C each depict pulse encoding methods according to embodiments of the present disclosure.

FIG. 5A depicts received pulses of two LiDAR systems with essentially no overlap between received pulse sequences of interest and interferers according to embodiments of the present disclosure.

FIG. 5B depicts a received pulse with a valid peak measurement according to embodiments of the present disclosure.

FIG. 6A depicts a pulse encoding scheme for a LiDAR system according to embodiments of the present disclosure.

FIG. 6B depict other pulse encoding schemes for a LiDAR system according to embodiments of the present disclosure.

FIG. 7 depicts a signature set with 8-bits for a pulse encoding scheme according to embodiments of the present disclosure.

FIG. 8 depicts a transmitter and receiver supporting a pulse encoding scheme and pulse decoding scheme according to embodiments of the present disclosure.

FIG. 9 depicts a flowchart for decoding a pulse sequence of a LiDAR system according to embodiments of the present disclosure.

FIG. 10 depicts a simplified block diagram of a computing device/information handling system according to embodiments of the present document.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims. Each reference mentioned in this patent document is incorporate by reference herein in its entirety.

Furthermore, one skilled in the art shall recognize that: (1) certain steps may optionally be performed; (2) steps may not be limited to the specific order set forth herein; (3) certain steps may be performed in different orders; and (4) certain steps may be done concurrently.

### A. Light Detection and Ranging System

A light detection and ranging system, such as a LiDAR system, may be a tool to measure the shape and contour of the environment surrounding the system. LiDAR systems may be applied to numerous applications including both autonomous navigation and aerial mapping of a surface. LiDAR systems emit a light pulse that is subsequently reflected off an object within the environment in which a system operates. The time each pulse travels from being emitted to being received may be measured (i.e., time-of-flight “TOF”) to determine the distance between the object and the LiDAR system. The science is based on the physics of light and optics. References made herein to a LiDAR system, or a light detection and ranging system, may also apply to other light detection systems.

In a LiDAR system, light may be emitted from a rapidly firing laser. Laser light travels through a medium and reflects off points of things in the environment like buildings, tree branches and vehicles. The reflected light energy returns to a LiDAR receiver (detector) where it is recorded and used to map the environment.

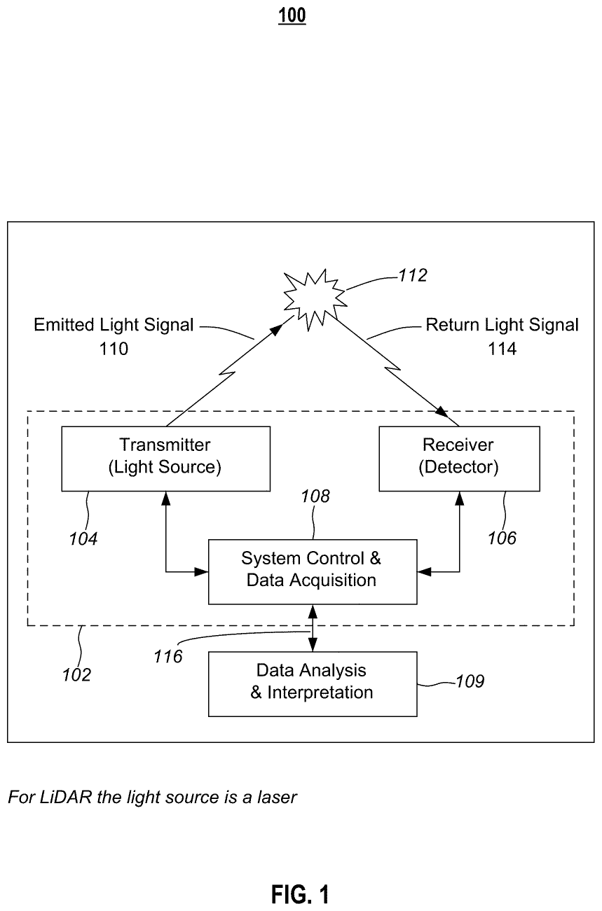

FIG. 1 depicts operation 100 of a light detection and ranging components 102 and data analysis & interpretation 109 according to embodiments of the present document. Light detection and ranging components 102 may comprise a transmitter 104 that transmits emitted light signal 110, receiver 106 comprising a detector, and system control and data acquisition 108. Emitted light signal 110 propagates through a medium and reflects off object 112. Return light signal 114 propagates through the medium and is received by receiver 106. System control and data acquisition 108 may control the light emission by transmitter 104 and the data acquisition may record the return light signal 114 detected by receiver 106. Data analysis & interpretation 109 may receive an output via connection 116 from system control and data acquisition 108 and perform data analysis functions. Connection 116 may be implemented with a wireless or non-contact communication method. Transmitter 104 and receiver 106 may include optical lens and mirrors (not shown). Transmitter 104 may emit a laser beam having a plurality of pulses in a particular sequence. In some embodiments, light detection and ranging components 102 and data analysis & interpretation 109 comprise a LiDAR system.

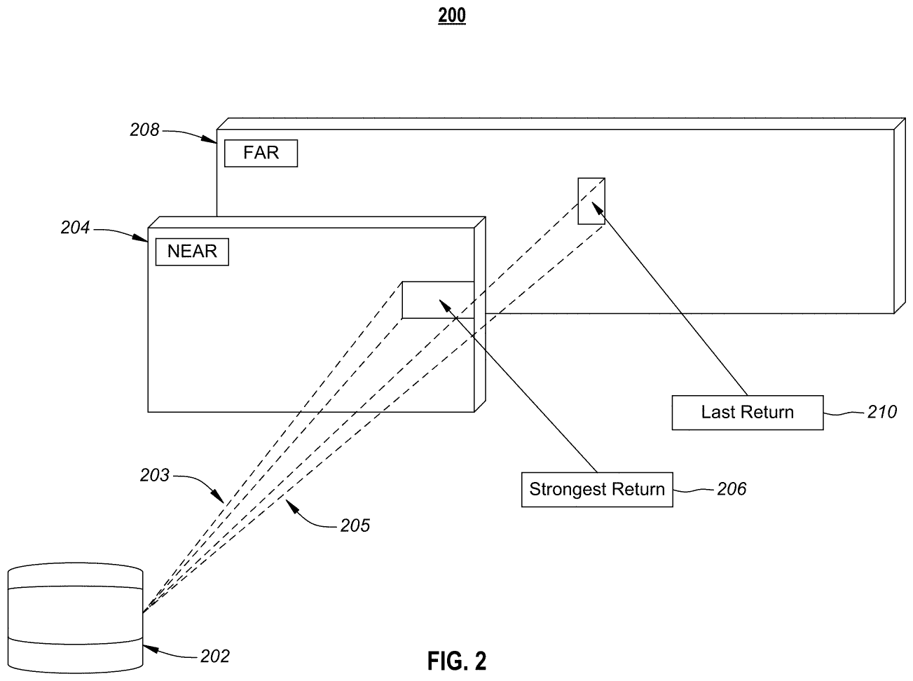

FIG. 2 illustrates the operation 200 of light detection and ranging system 202 including multiple return light signals: (1) return signal 203 and (2) return signal 205 according to embodiments of the present document. Light detection and ranging system 202 may be a LiDAR system. Due to the laser's beam divergence, a single laser firing often hits multiple objects producing multiple returns. The light detection and ranging system 202 may analyze multiple returns and may report either the strongest return, the last return, or both returns. Per FIG. 2, light detection and ranging system 202 emits a laser in the direction of near wall 204 and far wall 208. As illustrated, the majority of the beam hits the near wall 204 at area 206 resulting in return signal 203, and another portion of the beam hits the far wall 208 at area 210 resulting in return signal 205. Return signal 203 may have a shorter TOF and a stronger received signal strength compared with return signal 205. Light detection and ranging system 202 may record both returns only if the distance between the two objects is greater than minimum distance. In both single and multiple return LiDAR systems, it is important that the return signal is accurately associated with the transmitted light signal so that an accurate TOF is calculated.

Some embodiments of a LiDAR system may capture distance data in a 2-D (i.e. single plane) point cloud manner. These LiDAR systems may be often used in industrial applications and may be often repurposed for surveying, mapping, autonomous navigation, and other uses. Some embodiments of these devices rely on the use of a single laser emitter/detector pair combined with some type of moving mirror to effect scanning across at least one plane. This mirror not only reflects the emitted light from the diode, but may also reflect the return light to the detector. Use of a rotating mirror in this application may be a means to achieving 90-180-360 degrees of azimuth view while simplifying both the system design and manufacturability.

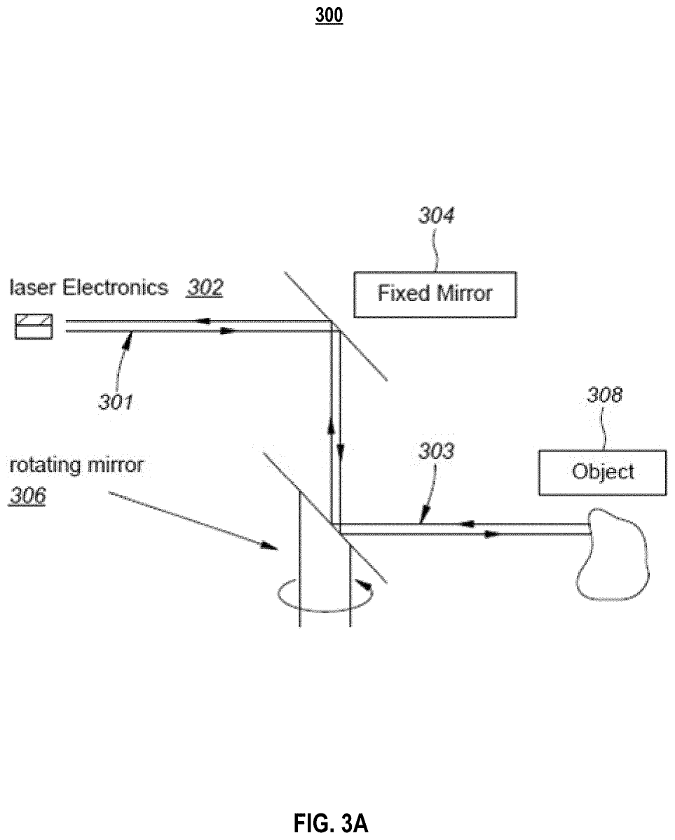

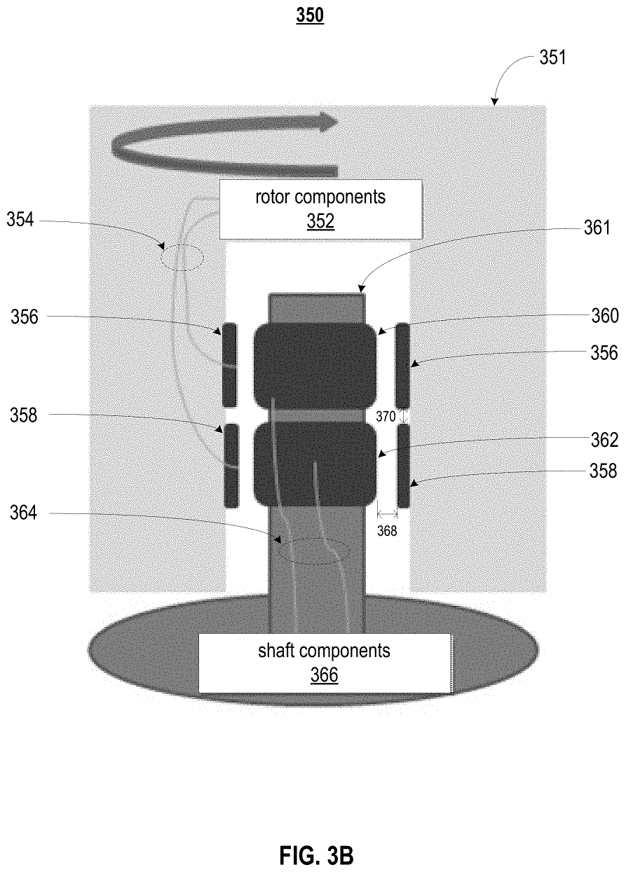

FIG. 3A depicts a LiDAR system 300 with a rotating mirror according to embodiments of the present document. LiDAR system 300 employs a single laser emitter/detector combined with a rotating mirror to effectively scan across a plane. Distance measurements performed by such a system are effectively two-dimensional (i.e., planar), and the captured distance points are rendered as a 2-D (i.e., single plane) point cloud. In some embodiments, but without limitations, rotating mirrors are rotated at very fast speeds e.g., thousands of revolutions per minute. A rotating mirror may also be referred to as a spinning mirror.

LiDAR system 300 comprises laser electronics 302, which comprises a single light emitter and light detector. The emitted laser signal 301 may be directed to a fixed mirror 304, which reflects the emitted laser signal 301 to rotating mirror 306. As rotating mirror 306 “rotates”, the emitted laser signal 301 may reflect off object 308 in its propagation path. The reflected signal 303 may be coupled to the detector in laser electronics 302 via the rotating mirror 306 and fixed mirror 304.

FIG. 3B depicts a LiDAR system 350 with rotating electronics in a rotor-shaft structure comprising a rotor 351 and a shaft 361 according to embodiments of the present document. Rotor 351 may have a cylindrical shape and comprise a cylindrical hole in the center of rotor 351. Shaft 361 may be positioned inside the cylindrical hole. As illustrated, rotor 351 rotates around shaft 361. These components may be included in a LiDAR system. Rotor 351 may comprise rotor components 352 and shaft 361 may comprise shaft components 366. Included in rotor components 352 is a top PCB and included in shaft components 366 is a bottom PCB. In some embodiments, rotor components 352 may comprise light detection and ranging components 102 and shaft components 366 may comprise data analysis & interpretation 109 of FIG. 1.

Coupled to rotor components 352 via connections 354 are ring 356 and ring 358. Ring 356 and ring 358 are circular bands located on the inner surface of rotor 351 and provide electrode plate functionality for one side of the air gap capacitor. Coupled to shaft components 366 via connections 364 are ring 360 and ring 362. Ring 360 and ring 362 are circular bands located on the outer surface of shaft 361 and provide electrode plate functionality for the other side of the air gap capacitor. A capacitor C1 may be created based on a space between ring 356 and ring 360. Another capacitor C2 may be created based on a space between ring 358 and ring 362. The capacitance for the aforementioned capacitors may be defined, in part, by air gap 368.

Ring 356 and ring 360 are the electrode plate components of capacitor C1 and ring 358 and ring 362 are the electrode plate components of capacitor C2. The vertical gap 370 between ring 356 and ring 358 may impact the performance of a capacitive link between capacitor C1 and capacitor C2 inasmuch as the value of the vertical gap 370 may determine a level of interference between the two capacitors. One skilled in the art will recognize that rotor 351 and shaft 361 may each comprise N rings that may support N capacitive links.

As previously noted, time of flight or TOF is the method a LiDAR system uses to map the environment and provides a viable and proven technique used for detecting target objects. Simultaneously, as the lasers fire, firmware within a LiDAR system may be analyzing and measuring the received data. The optical receiving lens within the LiDAR system acts like a telescope gathering fragments of light photons returning from the environment. The more lasers employed in a system, the more the information about the environment may be gathered. Single laser LiDAR systems may be at a disadvantage compared with systems with multiple lasers because fewer photons may be retrieved, thus less information may be acquired. Some embodiments, but without limitation, of LiDAR systems may be implemented in multiples of 8, i.e., 8, 16, 32 and 64 lasers. Also, some LiDAR embodiments, but without limitation, may have a vertical field of view (FOV) of 30-40° with laser beam spacing as tight as 0.3° and may have rotational speeds of 5-20 rotations per second.

The rotating mirror functionality may also be implemented with a solid state technology such as MEMS. Solid-state LiDAR sensors can enable hidden and low-profile sensing for a range of advanced driver-assistance systems (ADAS) and autonomous applications. One example, but without limitation, is the fixed laser, solid state Velarray™ LiDAR (Light Detection and Ranging) sensor, which can be a cost effective, high performance and rugged automotive product in a small form factor. In one embodiment, the Velarray™ LiDAR sensor may be implemented in a package size of 125 mm×50 mm×55 mm that can be embedded into the front, sides, and corners of vehicles. It may provide up to a 120 degree horizontal and 35 degree vertical field of view, with a 200 meter range even for low reflectivity objects.

### B. Pulse Encoding of a LiDAR Signal

One objective of embodiments of the present documents is the improvement in the reliability and accuracy for light detection and ranging systems. As used herein, the light detection and ranging system may be, but not limited to, a LiDAR system. In some embodiments, multi-return detection and pulse encoding of a laser beam may improve the performance of the LiDAR system. A motivation for pulse encoding may be the rejection of interference from other LiDAR sensors. A motivation for multiple return signals is to provide an ability to scan space with minimal sensor movement, and hence providing faster acquisition times for mapping data. There are number applications for which a single return signal may not provide enough accuracy and reliability. As with human vision system, one can see scenes which are partially occluded, e.g. seeing behind glass-doors/windows, seeing through mist, seeing through tree canopies etc. Multiple return signals from a LiDAR system may allow for mapping of partially occluded objects.

Imagine a helicopter or drone scanning a tree canopy shape for a forest survey. If there is only one return signal or two return signals available, the LiDAR system may have to carry out multiple missions to map out at various heights, and many of the acquisitions may be impossible with aerial survey. The LiDAR system may have to resort to manual point and shoot terrestrial survey methods for this application.

A LiDAR system may have the ability to analyze a return signal comprising a sequence of pulses and match the received sequence of pulses with a transmitted sequence of pulses in order to distinguish from other spurious pulses. Generally, a return signal may refer to a multi-return signal or a single return signal.

The reliability and accuracy of detection of a LiDAR return signal may be improved with a signature based on pulse encoding. A signature may uniquely identify a valid reflected light signal. A signature may be encoded or embedded in the pulses that are subsequently fired by the LiDAR system. When the LiDAR system receives a return signal, the LiDAR system may extract the signature from the single-return or multiple return signals and may determine if the decoded pulse(s) of the received return signal match the pulses transmitted in the laser beam. If the pulses do match, the return signal may be considered authenticated and data may be decoded from the return signal pulse(s). If the pulses do not match, the return signal may be considered a spurious signal, and the return signal may be discarded. Effectively, the system authenticates or validates the return signal using the characteristics of the transmitted pulses that comprises the embedded signature. The system may identify intentional or unintentional spurious return signals than may erroneously trigger a bogus return signal calculation. That is, the LiDAR system may distinguish and confirm the transmitted pulses from spurious pulses.

Signatures may be based, but without limitations, the number of pulses, the distance between pulses, the amplitude and ratio of amplitudes of the pulses and the shape of pulses. As an example of one signature, the number of pulses in a two firing sequences may comprise X pulses in a first sequence and Y pulses in a second sequence, where X is not equal to Y

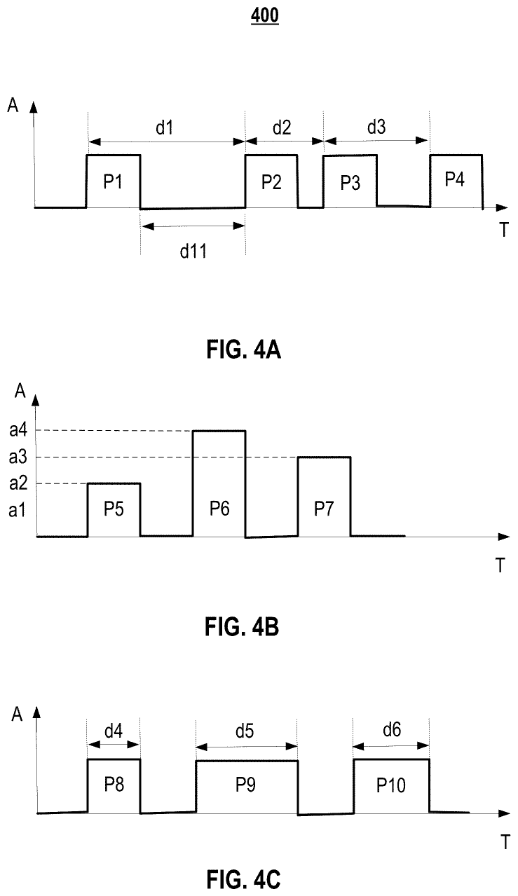

FIGS. 4A, 4B and 4C each depict a signature 400 according to embodiments of the present disclosure. In these figures, A represents the amplitude of the pulses and di represents distance in the time line, T. FIG. 4A illustrates a sequence of four pulses where a variation of distances between each pulse may define the signature. For example, the distance between pulse, P1, and pulse P2 may be distance d1. The distance between pulse, P2 and pulse P3 may be distance d2. The distance between pulse P3 and pulse P4 may be d3. As illustrated, d1>d3>d2. Alternatively, the distance between pulses may be defined as the distance between the following edge of a pulse and the leading edge of the next pulse, e.g., d11.

FIG. 4B illustrates a sequence of three pulses where a variation of the amplitudes may define the signature. For example, pulse P5 may have an amplitude of a2. Pulse P6 may have an amplitude of a4. Pulse P7 may have an amplitude of a3. As illustrated, a4>a3>a2. The signature may be based on a fixed ratio for the amplitudes of the pulses and/or the signature may be based on variable ratios between pulses and/or the signature may be based on the absolute amplitudes as defined by pre-determined or dynamic threshold.

FIG. 4C illustrates a sequence of three pulses where a variation of pulse shapes may define the signature. In the embodiment of FIG. 4C, the variation pulse shapes may be a variation of pulse widths. For example, pulse P8 may have a pulse width of d4. Pulse P9 may have a pulse width of d5. Pulse P10 may have a pulse width of d6, as illustrated d5>d6>d4.

One skilled in the art will recognize that the signatures may vary based on the application and environment in which embodiments of the invention are implemented, all of which are intended to fall under the scope of the invention. Signatures may be utilized separately or in combination. Signature detection may be implemented with fixed or variable thresholds.

Moreover, the system may include additional features to further improve the reliability and accuracy of return signal detection.

First, the LiDAR system may dynamically change the characteristics of the pulses for the next or subsequent laser firing. As previously discussed, the characteristics of the pulses may be defined by the signature. This feature allows the LiDAR system to respond to a spoofing attack of spurious pulses. A malicious party may be monitoring the transmitted laser beam or return signals in order to spoof the LiDAR system. With a static operation, rather than a dynamic operation, for the signature, the malicious party may be able to readily spoof the LiDAR system.

The LiDAR system may also dynamically change the signature for the next firing when the transmitted sequences of pulse match the return signal sequences of pulses. As noted, by dynamically changing the signature for the next laser firing, the potential for intentional or unintentional spoofing may be mitigated. Typically, the time for the time of flight (TOF) for a laser beam to travel to an object and be reflected back to the LiDAR system is a function of distance and speed of light. In this time period, the LiDAR system may analyze the return signal and decide to change or not the signature for the next laser firing.

In various embodiments, the LiDAR system may also dynamically change the transmitted sequence of pulses to include the signature as well as adapt the pulse sequence to the environment in which it operates. For example, if a LiDAR system is employed within an autonomous navigation system, weather patterns and/or traffic congestion may affect the manner in which the light signals propagate. In this embodiment, the LiDAR system may adjust the pattern of light pulses to not only uniquely identify it to a receiver but also to improve performance of the system based on the environment in which it operates.

Second, to add another element of security, the LiDAR system may randomly alter transmitted pulses. Encoding based on a random algorithm may be initiated by an instruction from a controller. This feature may be beneficial to mitigate the impact of non-intentional return signals. Unintentional return signals may increase with the growth of autonomous driving based on LiDAR systems.

### C. Pulse Encoding and Signatures for a LiDAR System

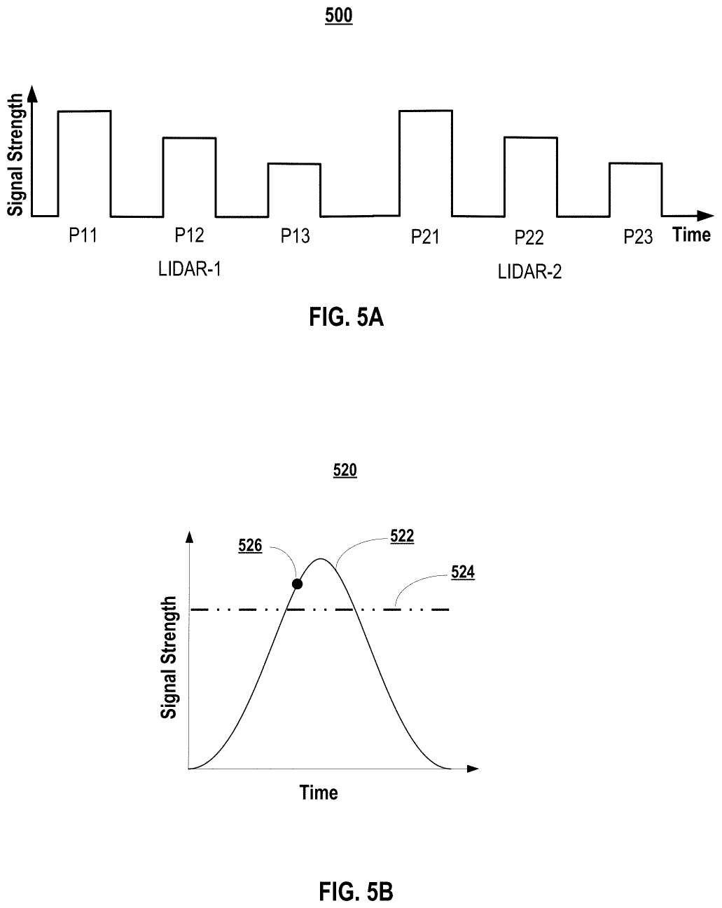

Detecting multi-return LiDAR signals may be problematic with the presence of other LiDAR signals or other optical signals. One scenario is illustrated in FIG. 5A. FIG. 5A depicts received pulses 500 from two LiDAR systems, LiDAR-1 and LiDAR-2, with essentially no overlap between received pulse sequences of interest and interferers (i.e., other LiDAR) in the time domain according to embodiments of the present disclosure Received pulses from LiDAR-1 include pulses P11, P12 and P13. Received pulses from LiDAR-2 include pulses P21, P22 and P23.

FIG. 5B depicts a received pulse 520 with a valid peak measurement according to embodiments of the present disclosure. The waveform for received pulse 520 is illustrated by waveform 522. The amplitude threshold 524 indicates the signal strength required for a valid pulse. Pulse measurement 526 is avoid the amplitude threshold 524 and therefore would indicate pulse 520 is a valid pulse.

As previously discussed, the reliability and accuracy of detection of a LiDAR return signal may be improved with a signature based on pulse encoding. A signature may uniquely identify a valid reflected light signal. A signature may be encoded or embedded in the pulses that are subsequently fired by the LiDAR system. When the LiDAR system receives a return signal, the LiDAR system may extract the signature from the single-return or multiple return signals and may determine if the decoded pulse(s) of the received return signal match the pulses transmitted in the laser beam. A signature may also be referred to as a “user signature” inasmuch as signatures may be assigned to different users or different systems.

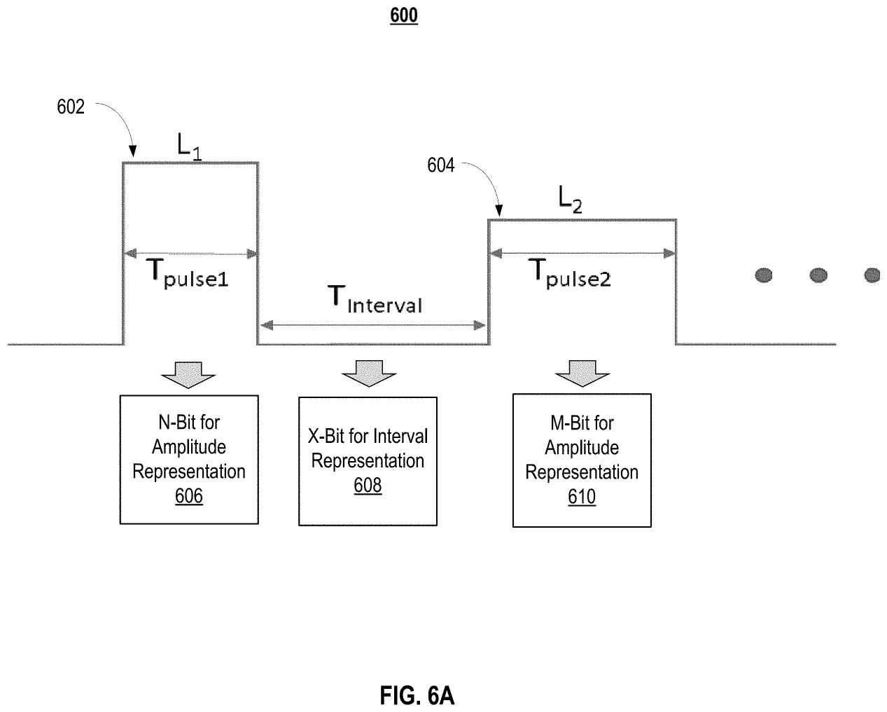

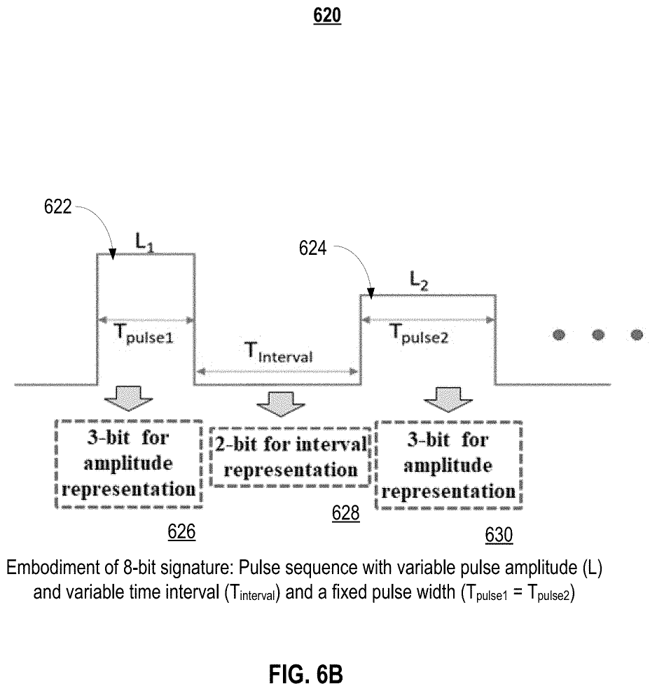

FIG. 6A depicts a pulse encoding scheme 600 for a LiDAR system according to embodiments of the present disclosure. A LiDAR system may send a limited number of multiple pulses from one laser. Pulse encoding scheme 600 illustrates the encoding of two pulses emitted from a LiDAR system. Pulse encoding scheme 600 comprises pulse1 602 and pulse2 604. Pulse1 602 may have an amplitude L1, and pulse width Tₚᵤₗₛₑ₁. Pulse1 602 may have an amplitude L2, and pulse width Tₚᵤₗₛₑ₂. The pulse interval between pulse1 602 and pulse2 604 may be Tᵢₙₜₑᵣᵥₐₗ. A signature for the pulse encoding scheme 600 may be determined by assigning bit patterns for these variables including the amplitudes, pulse widths, and pulse intervals. Per pulse encoding scheme 600, N-bits may be assigned for the amplitude representation 606 of pulse1 602, M-bits may be assigned for the amplitude representation 610 of pulse2 604, and X-bits may be assigned for the interval representation 608 of Tᵢₙₜₑᵣᵥₐₗ. The user signature may be represented by Z-bits, where the amplitude of the first pulse is represented by N-bits, the interval is represented by X-bits, and the amplitude of the second pulse is represented by M-bits. Z-bits is equal to the sum of N-bits plus X-bits plus M-bits. (i.e., N-bits+X-bits+M-bits) A peak ratio may be based on the N-bits and the M-bits, and the pulse interval may be based on X-bits. In another embodiment, the user signature maybe represented by a multiple of Z-bits. Although not illustrated, another embodiment may assign Y-bits to indicate variables/values for Tₚᵤₗₛₑ₁ and Tₚᵤₗₛₑ₂. One skilled in the art may recognize that a LiDAR system may be implemented with a signature with a combination of bits for pulse amplitudes and/or pulse intervals and/or pulse widths. For satisfactory operation, the aforementioned parameters should equal or exceed a tolerance threshold.

FIG. 6B depicts pulse encoding scheme 620 for a LiDAR system according to embodiments of the present disclosure. FIG. 6B illustrates an embodiment of a 8-bit signature, which comprises the following characteristics: the pulse sequence comprises variable pulse amplitudes, (Li), variable time interval (Tᵢₙₜₑᵣᵥₐₗ) and a fixed pulse width where Tₚᵤₗₛₑ₁=Tₚᵤₗₛₑ₂. As illustrated, FIG. 6B includes pulse 622 with amplitude L1 and pulse width Tₚᵤₗₛₑ₁, and includes pulse 624 with amplitude L2 and pulse width Tₚᵤₗₛₑ₂. The pulse interval between pulse 622 and pulse 624 is Tᵢₙₜₑᵣᵥₐₗ. For pulse encoding scheme 620, a signature may be assigned with 3-bits for amplitude representation 626 for pulse 622, 2-bits for interval representation 628, and 3-bits for amplitude representation 630 for pulse 624. This signature may be referred to as a 3×2×3 bit signature (i.e., 8 bits: 12345678) based on the bit configuration illustrated in FIG. 6B. The peak ratio may be defined based on bits 1-3 and bits 6-8. The pulse interval may be defined based on bits 4-5. In one embodiment, based on the user signature, the sequences of pulses comprise variable pulse amplitudes, variable time intervals between pulses, and a fixed pulse width for each pulse. In another embodiment, based on the user signature, the sequences of pulses comprise variable pulse amplitudes, variable time intervals between pulses, and a fixed pulse width for each pulse.

In summary, with embodiments having received pulses 500, i.e., no overlapping pulses between return pulses from separate LiDAR firings, the encoding schemes for FIG. 6B offer a capability to extend to more users, more power levels and more pulses. Since the period of pulse sequence is relatively short, there may be less probability of overlap of multi-return signals and less range reduction. Overall, the probability of detection for embodiments with received pulses 500 with pulse encoding scheme 620 may exceed 99%.

A mathematical model for the design of a signature set may be based on the following problem statement:

Design signature set:

S={s₁,s₂, . . . ,s_{K}},s∈{±1}^{L}

with K user signatures of length L, such that total squared correlation (TSC) of set S is minimized, i.e.,

$${min}_{S} TSC ( S ) {=}^{Δ} {\sum }_{i = 1}^{K} {\sum }_{j = 1}^{K} {\vert {s}_{i}^{H} {s}_{j} \vert}^{2}$$

It is proved [1] that the lower bound on TSC of signature sets.

$$TSC ( S ) \geq \frac{{K}^{2}}{L}$$

Hadamard matrix with K=L and K is some order of 2 and can achieve the lower bound.
[1] R. L. Welch, “Lower bounds on the maximum cross correlation of signals,” IEEE Trans. Inform. Theory, vol. IT-20, pp. 397-399, May 1974.

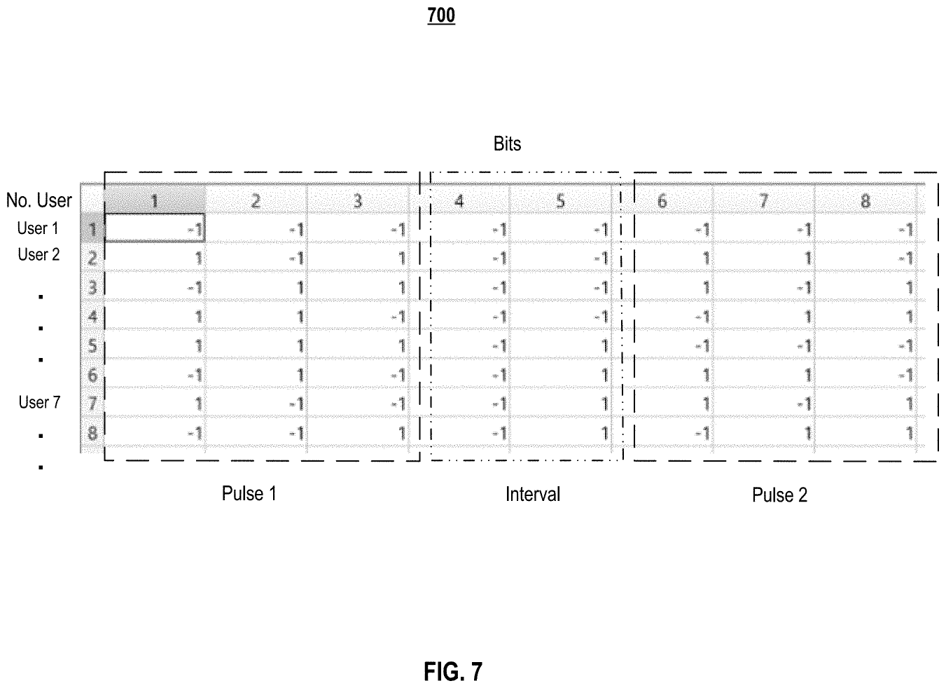

An exemplary signature set with an 8-bit length may be illustrated with a permutated Hadamard matrix. FIG. 7 depicts a signature set 700 with 8-bits for a pulse encoding scheme utilizing a permutated Hadamard matrix according to embodiments of the present disclosure. That is, the user signature may be represented by 8-bits. As illustrated, signature set 700 may be represented by 3-bits for pulse 1, 2-bits for interval, and 3-bits for pulse 2 (i.e., 3×2×3 bit signature). The y-axis indicates the signature assignment for different users, user1, user 2, etc. User signatures may be orthogonal to each other, then a correlation calculation (inner product) can identify pulse sequence to the corresponding LiDAR system when correlation is maximum. With the user signatures orthogonal to each other, there may be no overlap with other users and minimum interference. Hence, a bit representation of the user signature is orthogonal to a bit representation of another user signature of another LiDAR system.

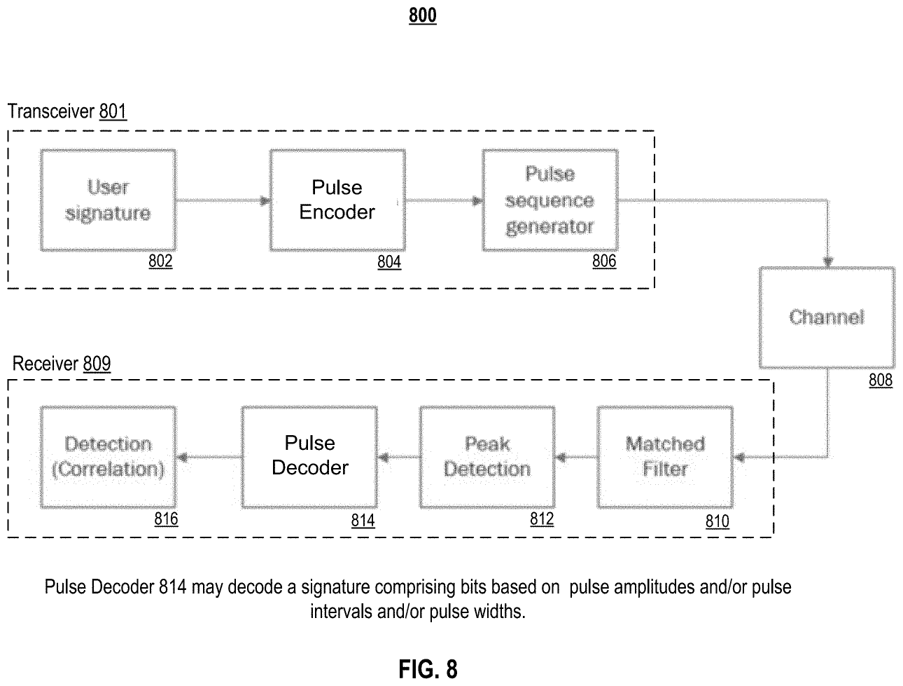

FIG. 8 depicts a network 800 comprising a LiDAR system including a transmitter 801 and a receiver 809 that support a pulse encoding scheme and pulse decoding scheme according to embodiments of the present disclosure. Transmitter 801 may be operable to optically transmit a sequence of data. The transmitter 801 and receiver 809 may be configured to support signatures with various combinations of bits, for example, but without limitations, for pulse amplitudes and/or pulse intervals and/or pulse widths. The LiDAR system may also comprise a controller (not shown).

For example, transmitter 801 and receiver 809 may be configured to support the functionality of FIG. 6B. The transmitter 801 may comprise user signature 802, which stores the signature for the LiDAR system. Based on the user signature 802, multiple pulses may be encoded via pulse encoder 804, and subsequently a pulse sequence may be generated and fired by pulse sequence generator 806 into channel 808. For pulse encoding scheme 620, pulse encoder 804 encodes two pulses based on user signature 802.

Receiver 809 comprises a matched filter 810, peak detection 812, pulse decoder 814, and detection (correlation) 816. A return signal may be received from channel 808 and processed by matched filter 810 in order to optimize the S/N ratio of the return signal. The optimized signal may be coupled to peak detection 812, which generates a peak return signal. With the knowledge of the signature, pulse decoder 814 decodes the peak ratio and the pulse interval. These calculations are correlated and validated by detection (correlation) 816.

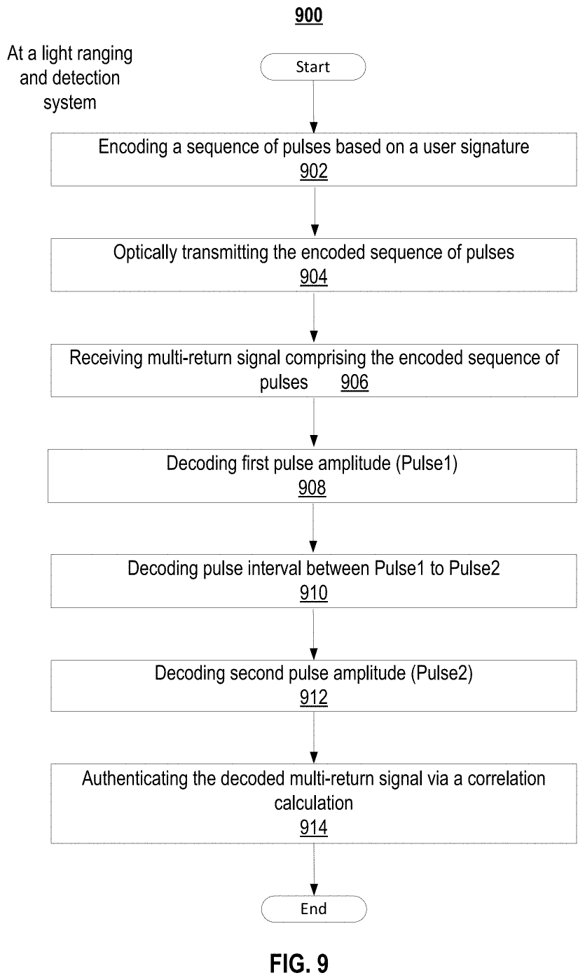

FIG. 9 depicts a flowchart 900 for encoding and decoding a pulse sequence of a LiDAR system according to embodiments of the present disclosure. The pulse sequence may comprise a 3×2×3 signature as was described for FIG. 6B (pulse encoding scheme 620). The method comprises the steps of:

Encoding a sequence of pulses based on a user signature. (step 902)

Optically transmitting the encoded sequence of pulses. (step 904)

Receiving a multi-return signal comprising the encoded sequence of pulses. (step 906)

Decoding a first pulse in the encoded sequences of pulses amplitude (Pulse1). (step 908)

Decoding pulse interval between first pulse and the next pulse. (Pulse1 and Pulse2). (step 910)

Decoding second/next pulse amplitude. (Pulse2) (step 912)

Authenticating the decoded multi-return signal via a correlation calculation. The authentication may be partially determined based on maintaining a tolerance margin for a shape of received pulses from the sequence of pulses relative to a shape of the transmitted pulses of the sequence of pulses (step 914)

In summary, each LiDAR system may be manufactured with a specific user signature based on pulse encoding. The specific signature may be determined based an assignment of a specific number of bits for pulse amplitudes and/or pulse intervals and/or pulse widths. The signature may be based on any or all of the aforementioned parameters. Optionally, the LiDAR system may be designed with a controller that may dynamically assign signatures to determine the pulse encoding of the laser firing. That is, for a next sequence of pulses to be transmitted, the pulse encoder may dynamically change the user signature.

### D. System Embodiments

In embodiments, aspects of the present patent document may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be an optical measuring system such as a LiDAR system that uses time of flight to map objects within its environment. The computing system may include random access memory (RAM), one or more processing resources such as a central processing unit (CPU) or hardware or software control logic, ROM, and/or other types of memory. Additional components of the computing system may include one or more network or wireless ports for communicating with external devices as well as various input and output (I/O) devices, such as a keyboard, a mouse, touchscreen and/or a video display. The computing system may also include one or more buses operable to transmit communications between the various hardware components.

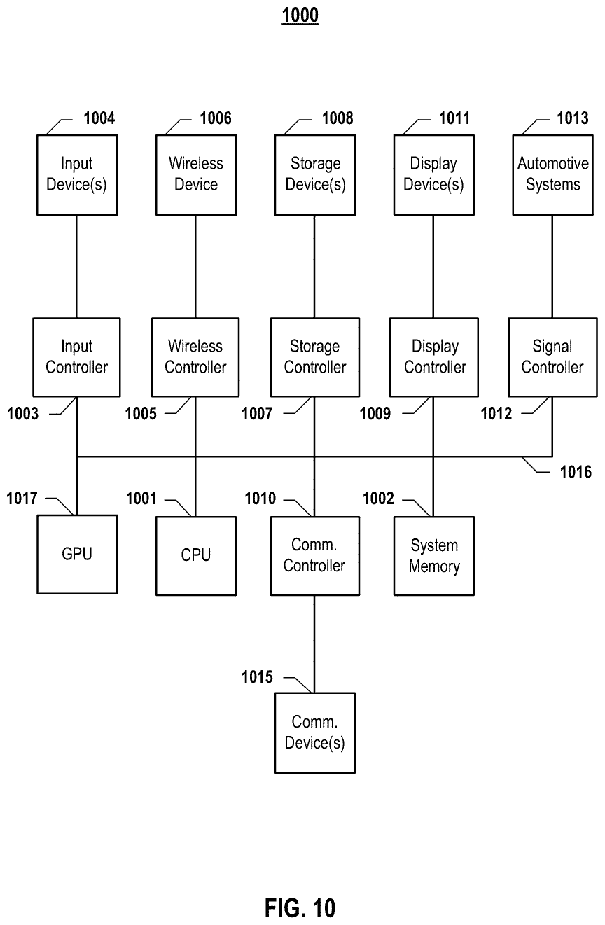

FIG. 10 depicts a simplified block diagram of a computing device/information handling system (or computing system) according to embodiments of the present disclosure. It will be understood that the functionalities shown for system 1000 may operate to support various embodiments of an information handling system—although it shall be understood that an information handling system may be differently configured and include different components.

As illustrated in FIG. 10, system 1000 includes one or more central processing units (CPU) 1001 that provides computing resources and controls the computer. CPU 1001 may be implemented with a microprocessor or the like, and may also include one or more graphics processing units (GPU) 1017 and/or a floating point coprocessor for mathematical computations. System 1000 may also include a system memory 1002, which may be in the form of random-access memory (RAM), read-only memory (ROM), or both.

A number of controllers and peripheral devices may also be provided, as shown in FIG. 10. An input controller 1003 represents an interface to various input device(s) 1004, such as a keyboard, mouse, or stylus. There may also be a wireless controller 1005, which communicates with a wireless device 1006. System 1000 may also include a storage controller 1007 for interfacing with one or more storage devices 1008 each of which includes a storage medium such as flash memory, or an optical medium that might be used to record programs of instructions for operating systems, utilities, and applications, which may include embodiments of programs that implement various aspects of the present invention. Storage device(s) 1008 may also be used to store processed data or data to be processed in accordance with the invention. System 1000 may also include a display controller 1009 for providing an interface to a display device 1011. The computing system 1000 may also include an automotive signal controller 1012 for communicating with an automotive system 1013. A communications controller 1010 may interface with one or more communication devices 1015, which enables system 1000 to connect to remote devices through any of a variety of networks including an automotive network, the Internet, a cloud resource (e.g., an Ethernet cloud, an Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 1016, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method comprising:
encoding, at a LiDAR system, a sequence of pulses based on a user signature;
transmitting, at the LiDAR system, the sequences of pulses;
receiving, at the LiDAR system, a multi-return signal based on a reflection off objects of the sequences of pulses;
decoding, at the LiDAR system, the multi-return signal utilizing the user signature; and
authenticating, at the LiDAR system, the decoded multi-return signal via a correlation calculation,
wherein a bit representation of the user signature is orthogonal to a bit representation of another user signature of another LiDAR system.

2. The method of claim 1, wherein the user signature determines an amplitude of a first pulse in the sequence of pulses, an amplitude of a second pulse of the sequence of pulses, and an interval between the first pulse and the second pulse.

3. The method of claim 2, wherein the user signature is represented by Z-bits.

4. The method of claim 3, wherein the amplitude of the first pulse is represented by N-bits, the interval is represented by X-bits, and the amplitude of the second pulse is represented by M-bits, wherein Z-bits is equal to a sum of N-bits plus X-bits plus M-bits.

5. The method of claim 4, wherein a peak ratio is based on the N-bits and the M-bits, and the interval is based on the X-bits.

6. The method of claim 2, wherein based on the user signature, the sequences of pulses comprise fixed pulse amplitudes, variable time intervals between pulses, and a fixed pulse width for each pulse.

7. The method of claim 2, wherein based on the user signature, the sequences of pulses comprise variable pulse amplitudes, variable time intervals between pulses, and a fixed pulse width for each pulse.

8. The method of claim 1, further comprising generating, by the LiDAR system, the user signature for the sequence of pulses based on amplitudes of each of the pulses, in the sequences of pulses, and/or intervals between each of the pulses, in the sequences of pulses, and/or a pulse widths of each of the pulses.

9. The method of claim 1, further comprising dynamically adjusting, by the LiDAR system, the user signature.

10. The method of claim 1, further comprising configuring each LiDAR system with a specific user signature.

11. The method of claim 1, wherein the user signature is represented by a multiple of Z-bits.

12. The method of claim 1, wherein, the authentication is partially determined based on maintaining a tolerance margin for a shape of received pulses from the sequence of pulses relative to a shape of the transmitted pulses of the sequence of pulses.

13. A system comprising:
a user signature capable to specify characteristics for a sequence of pulses;
a pulse encoder operable to generate the sequence of pulses based on the user signature;
a transmitter operable to optically transmit the sequence of pulses;
a pulse decoder operable to decode, using the user signature, a return signal comprising a reflection off objects of the sequence of pulses; and
a correlation calculation operable to authenticate the decoded return signal,
wherein a bit representation of the user signature is orthogonal to a bit representation of another user signature of another LiDAR system.

14. The system of claim 13, wherein if the decoded return signal matches characteristics of the optically transmitted sequence of pulses, the correlation calculation authenticates the decoded return signal.

15. The system of claim 13, if the decoded return signal does not match characteristics of the optically transmitted sequence of pulses, the system disregards the decoded return signal.

16. The system of claim 13, wherein the user signature is represented by Z-bits.

17. The system of claim 13, wherein based on the user signature, the sequences of pulses comprise variable pulse amplitudes, variable time intervals between pulses, and a fixed pulse width for each pulse.

18. The system of claim 13, wherein for a next sequence of pulses to be transmitted, the pulse encoder dynamically changes the user signature.

19. The system of claim 13, further comprising generating, by a LiDAR system, the user signature for the sequence of pulses based on amplitudes of each of the pulses, in the sequences of pulses, and/or intervals between each of the pulses, in the sequences of pulses, and/or a pulse widths of each of the pulses.

20. A non-transitory computer readable storage medium having computer program code stored thereon, the computer program code, when executed by one or more processors implemented on a light detection and ranging system, causes the light detection and ranging system to perform a method comprising:
encoding a sequence of pulses based on a user signature;
transmitting the sequences of pulses;
receiving a multi-return signal based on a reflection of the pulses;
decoding the multi-return signal utilizing the user signature; and
authenticating the decoded multi-return signal via a correlation calculation.
